(19) United States
(12) Patent Application Publication
(10) Pub. No.: US 2025/0157046 A1
(43) Pub. Date: May 15, 2025

(54) MOTION EVALUATION APPARATUS, MOTION EVALUATION METHOD, AND NON-TRANSITORY COMPUTER-READABLE MEDIUM

(71) Applicant: NEC Corporation, Minato-ku, Tokyo (JP)

(72) Inventors: Noboru YOSHIDA, Tokyo (JP); Ryo KAWAI, Tokyo (JP); Jianquan LIU, Tokyo (JP)

(73) Assignee: NEC Corporation, Minato-ku, Tokyo (JP)

(21) Appl. No.: 18/836,400

(22) PCT Filed: Mar. 18, 2022
(86) PCT No.: PCT/JP2022/012755

§ 371 Date: Aug. 7, 2024

(51) Int. Cl. G06T 7/20; G06V 20/40

(52) U.S. Cl. CPC G06T 7/20; G06V 20/48; G06T 2207/10016; G06T 2207/30196

(57) ABSTRACT

A motion evaluation apparatus includes: motion identification unit for extracting skeletal information of a person in an acquired image and identifying an evaluation target motion related to a body of the person based on the extracted skeletal information of the person and a registered motion pattern formed by stored skeletal information; and evaluation unit for evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

### TECHNICAL FIELD

The present disclosure relates to a motion evaluation apparatus, a motion evaluation method, and a non-transitory computer-readable medium.

### BACKGROUND ART

Systems that detect motions of people and evaluate similarity and efficiency are used.

For example, Patent Literature 1 discloses a motion similarity evaluation apparatus including:
means for acquiring a sample video; means for acquiring a mimic video; means for extracting skeletal information of each motion from the sample video and the mimic video; and
means for evaluating similarity of each motion based on similarity of each piece of skeletal information at a synchronization time.

### CITATION LIST

### Patent Literature

Patent Literature 1: Japanese Unexamined Patent Application Publication No. 2020-195648

### SUMMARY OF INVENTION

### Technical Problem

However, in Patent Literature 1, only similarity of each motion is evaluated based on similarity of each piece of skeletal information at a synchronization time, and the motion of a person cannot be evaluated appropriately.

In view of the above-described problem, an object of the present disclosure is to provide a motion evaluation apparatus, a motion evaluation method, and a non-transitory computer-readable medium capable of appropriately evaluating a motion.

### Solution to Problem

According to an aspect of the present disclosure, a motion evaluation apparatus includes:
motion identification means for extracting skeletal information of a person in an acquired image and identifying an evaluation target motion related to a body of the person based on the extracted skeletal information of the person and a registered motion pattern formed by stored skeletal information; and
evaluation means for evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

According to another aspect of the present disclosure, a motion evaluation method includes:
extracting skeletal information of a person in an acquired image and identifying an evaluation target motion related to a body of the person based on the extracted skeletal information of the person and a registered motion pattern formed by stored skeletal information; and
evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

According to still another aspect of the present disclosure, a non-transitory computer-readable medium stores a program that causes a computer to execute:
a process of extracting skeletal information of a person in an acquired image and identifying an evaluation target motion related to a body of the person based on the extracted skeletal information of the person and a registered motion pattern formed by stored skeletal information; and
a process of evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

### Advantageous Effects of Invention

According to the present disclosure, it is possible to provide a motion evaluation apparatus, a motion evaluation method, and a non-transitory computer-readable medium capable of appropriately evaluating a motion.

### BRIEF DESCRIPTION OF DRAWINGS

FIG. 1 is a block diagram illustrating a configuration of a motion evaluation apparatus according to a first example embodiment.

FIG. 2 is a flowchart illustrating a motion evaluation method according to the first example embodiment.

FIG. 3 is a diagram illustrating an overall configuration of a motion evaluation system according to a second example embodiment.

FIG. 4 is a block diagram illustrating a configuration of a server according to the second example embodiment.

FIG. 5 is a diagram illustrating skeletal information extracted from a frame image included in video data according to the second example embodiment.

FIG. 6 is a diagram illustrating an example of registered skeletal information according to the second example embodiment.

FIG. 7 is a diagram illustrating an example in which similarity is evaluated in consideration of a deviation amount in a temporal axis direction between a sample motion and an evaluation target motion.

FIG. 8 is a diagram illustrating an example in which similarity is evaluated in consideration of a deviation amount in a spatial axis direction at a synchronization time between skeletal information of the sample motion and skeletal information of the evaluation target motion.

FIG. 9 is a flowchart illustrating a video data acquisition method by a motion evaluation apparatus according to the second example embodiment.

FIG. 10 is a flowchart illustrating a registered motion ID and a registered motion sequence registration method by the server according to the second example embodiment.

FIG. 11 is a flowchart illustrating a motion evaluation method according to the second example embodiment.

FIG. 12 is a diagram illustrating an overall configuration of a motion evaluation system according to a third example embodiment.

FIG. 13 is a block diagram illustrating a configuration of a server according to the third example embodiment.

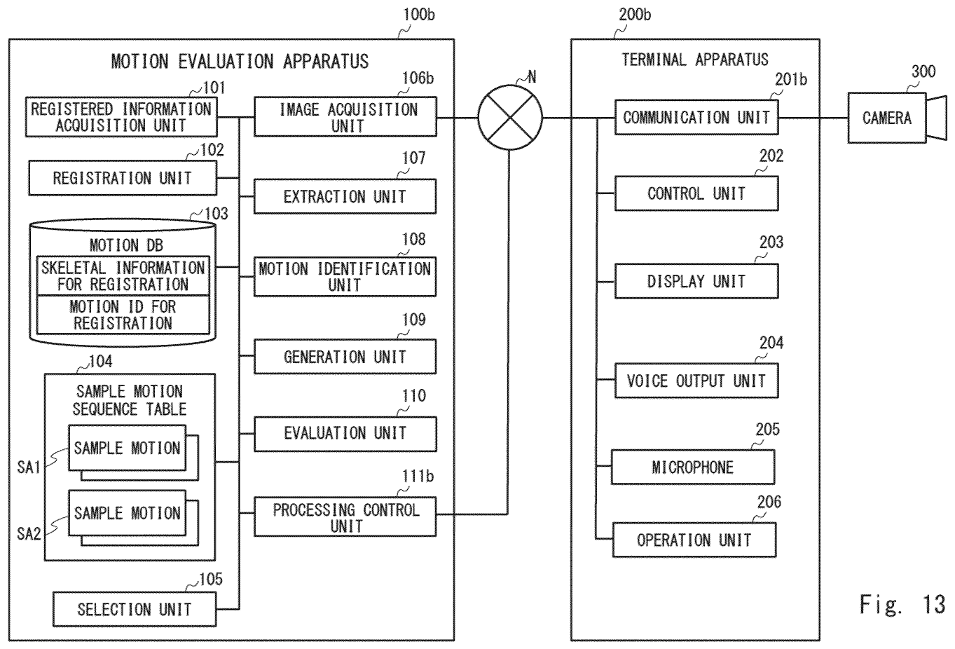

FIG. 14 is a block diagram illustrating a hardware configuration example of the motion evaluation apparatus and the like.

### EXAMPLE EMBODIMENT

Hereinafter, the present disclosure will be described according to example embodiments, but the disclosure described in the claims is not limited to the following example embodiments. Not all the configurations described in the example embodiments are essential as means for solving the problem. In the drawings, the same elements are denoted by the same reference numerals, and repeated description will be omitted as necessary.

### First Example Embodiment

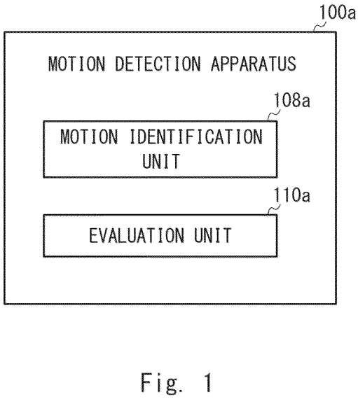

FIG. 1 is a block diagram illustrating a configuration of a motion evaluation apparatus 100a according to a first example embodiment. The motion evaluation apparatus 100a is a computer that images a user U performing a predetermined motion and compares the predetermined motion with a sample motion to evaluate the motion of the user U. The motion evaluation apparatus 100a can evaluate quality and efficiency of work and identify a proficient level (for example, an advanced-level person, an intermediate-level person, a beginner, and the like) of a motion (for example, a dance) of a person by evaluating a motion of a worker. The motion evaluation apparatus 100a includes a motion identification unit 108a and an evaluation unit 110a.

The motion identification unit 108a is also referred to as motion identification means. The motion identification unit 108a extracts skeletal information of the person in the acquired image and identifies an evaluation target motion related to the body of the person based on the extracted skeletal information of the person and a registered motion pattern formed by stored skeletal information.

The body of the person may be at least a part of the body that defines a posture such as a hand, a shoulder, a trunk, a leg, a face, and a neck and specifically may be a skeleton of the whole body or a skeleton corresponding to a part of the body (for example, only the hand or only the upper body).

The evaluation unit 110a is also referred to as evaluation means. The evaluation unit 110a evaluates similarity between the evaluation target motion and the sample motion pattern formed by the stored skeletal information, based on an integrated evaluation value including a first evaluation value that is based on a deviation amount of the skeletal information in the temporal axis direction and a second evaluation value that is based on a deviation amount of the skeletal information of the person in the spatial axis direction.

The deviation amount of the skeletal information in the temporal axis direction is calculated from a distance between the associated frames by matching a sample motion pattern and a motion start point of an evaluation target motion and associating each frame based on similarity of the skeletal information of each frame.

The deviation amount of the skeletal information in the spatial axis direction is calculated based on a deviation amount of a geometric shape of the skeletal information by associating a similar sample motion with the evaluation target motion.

A registered motion pattern may be reference data stored in advance to identify a motion of the person. The sample motion pattern may also be reference data stored in advance to evaluate the motion of the person. In several example embodiments, the registered motion pattern may include a sample motion pattern.

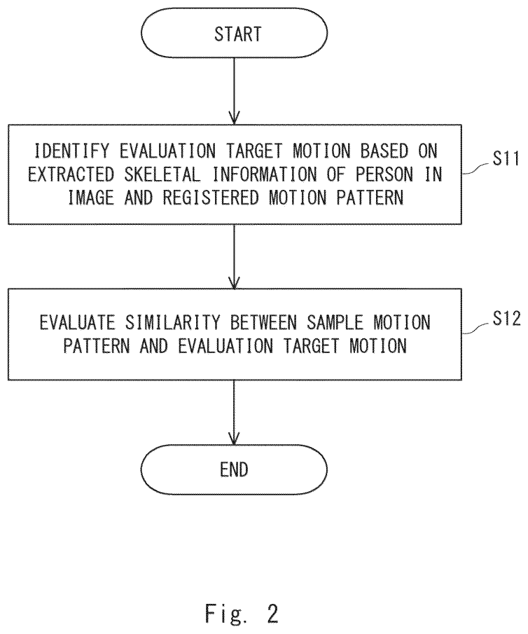

FIG. 2 is a flowchart illustrating a motion evaluation method according to the first example embodiment.

The motion identification unit 108a extracts the skeletal information of the person in an acquired image and identifies an evaluation target motion related to the body of the person based on the extracted skeletal information of the person and the registered motion pattern formed by the stored skeletal information (step S11). The evaluation unit 110a evaluates the similarity between the evaluation target motion and the sample motion pattern formed by the stored skeletal information, based on the integrated evaluation value including the first evaluation value that is based on the deviation amount of the skeletal information in the temporal axis direction and the second evaluation value that is based on the deviation amount of the skeletal information of the person in the spatial axis direction (step S12).

According to the first example embodiment, not only a deviation in the motion in the spatial axis direction but also a deviation in the motion in the temporal axis direction can be evaluated. Accordingly, it is possible to provide a motion evaluation apparatus, a motion evaluation method, and the like capable of appropriately evaluating a motion of the person.

### Second Example Embodiment

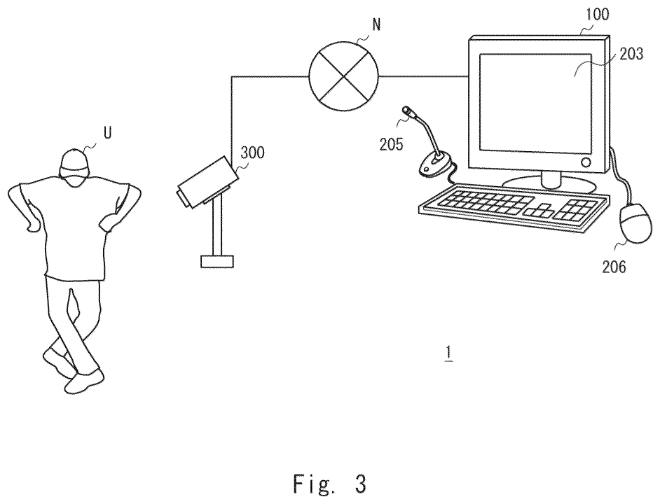

FIG. 3 is a diagram illustrating an overall configuration of a motion evaluation system 1 according to a second example embodiment. The motion evaluation system 1 is a computer system that images a user U performing a predetermined motion and compares the predetermined motion with a sample motion to evaluate the motion of the user U. In the following description, evaluation of a dance will be mainly described, but the present disclosure is not limited thereto. The present disclosure is also applicable to, for example, a case in which quality and a proficiency level of work is evaluated by the worker.

The motion evaluation system 1 includes a motion evaluation apparatus 100 and a camera 300. The motion evaluation apparatus 100 is communicably connected to the camera 300 via a network N. The network N may be wired or wireless. The motion evaluation apparatus 100 may be a local computer (for example, a desktop computer, a laptop computer, a tablet, a smartphone, or the like) or a server computer. In addition, the motion evaluation apparatus 100 may be configured by a single computer or may be configured by a plurality of computers.

The camera 300 captures an image of the user U performing the predetermined motion. The camera 300 is disposed at a position and an angle at which at least a part of the body of the user U can be imaged. In the second example embodiment, the camera 300 may include a plurality of cameras.

The motion evaluation apparatus 100 is a computer apparatus that evaluates a motion of the user U by comparing the motion with sample motion data based on the video data received from the camera 300. The motion evaluation apparatus 100 can be used by the user U or a person who evaluates a motion of the user U (hereinafter referred to as an evaluator) to visually recognize an evaluation result.

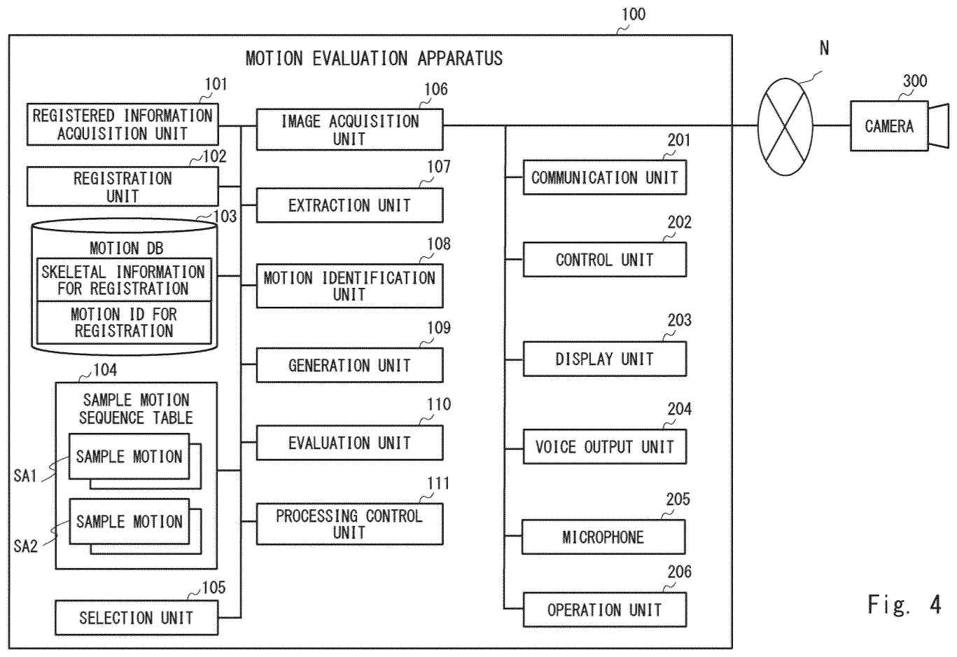

FIG. 4 is a block diagram illustrating a configuration of the motion evaluation apparatus 100 according to the second example embodiment.

### (Motion Evaluation Apparatus 100)

The motion evaluation apparatus 100 includes a communication unit 201, a control unit 202, a display unit 203, a voice output unit 204, a microphone 205, and an operation unit 206.

The communication unit 201 is also referred to as communication means. The communication unit 201 is a communication interface with the network N. The communication unit 201 is connected to the camera 300 and can acquire video data from the camera 300 at predetermined time intervals.

The control unit 202 is also referred to as control means. The control unit 202 controls hardware included in the motion evaluation apparatus 100. For example, in a case where the control unit 202 detects a start trigger, the motion evaluation apparatus 100 starts acquiring video data from the camera 300. The detection of the start trigger refers to, for example, “detecting start of dance music by a microphone” or “operating the motion evaluation apparatus 100 to start evaluation of a motion of the user by the evaluator”. For example, in a case where the control unit 202 detects an end trigger, the motion evaluation apparatus 100 ends the acquisition of the video data from the camera 300. The detection of the end trigger refers to “detecting end of dance music by a microphone” or “operating the motion evaluation apparatus 100 to end the evaluation of the motion of the user by the evaluator”, as described above. The start trigger and the end trigger are exemplary and can be modified in various forms.

In a case where the motion evaluation apparatus 100 evaluates the motion of the user as good or bad, the control unit 202 may cause the display unit 203 to display a predetermined display according to an evaluation result. Furthermore, the control unit 202 may cause the voice output unit 204 to output a predetermined sound according to the evaluation result.

The display unit 203 is a display device. The voice output unit 204 is a voice output device including a speaker. The microphone 205 acquires an external sound (for example, dance music). The operation unit 206 is a mouse, a keyboard, a touch panel, or the like and receives an input of an operator.

The motion evaluation apparatus 100 includes a registered information acquisition unit 101, a registration unit 102, a motion DB 103, a sample motion sequence table 104, a selection unit 105, an image acquisition unit 106, an extraction unit 107, a motion identification unit 108, a generation unit 109, an evaluation unit 110, and a processing control unit 111.

The registered information acquisition unit 101 is also referred to as registered information acquisition means. The registered information acquisition unit 101 acquires a plurality of pieces of video data for registration through an operation of an administrator of the motion evaluation apparatus 100. In the second example embodiment, each piece of video data for registration can be video data indicating a motion of a person. Each piece of video data for registration may be video data indicating a sample motion or may be video data indicating a motion of a normal person who is not a sample. The sample motion can be, for example, video data obtained by imaging various dances (for example, hip hop or tango) by an expert dancer. The video data for registration includes an individual motion (for example, a unit motion included in a dance such as a box step). In the second example embodiment, the video data for registration is a moving image including a plurality of frame images, but may be a still image (one frame image). The registered motion pattern can be used to identify a motion of the person. The registered motion pattern related to the sample motion can be used to evaluate a motion of the person to be described below.

The registered information acquisition unit 101 acquires a plurality of registered motion IDs and information regarding the time-series order in which the motion is performed in a series of motions through an operation of the administrator of the motion evaluation apparatus 100.

The registered information acquisition unit 101 supplies the acquired information to the registration unit 102.

The registration unit 102 is also referred to as registration means. First, the registration unit 102 executes a motion registration process in response to a motion registration request. Specifically, the registration unit 102 supplies the video data for registration to the extraction unit 107 to be described below and acquires the skeletal information extracted from the video data for registration from the extraction unit 107 as registered skeletal information. Then, the registration unit 102 registers the acquired registered skeletal information in the motion DB 103 in association with the registered motion ID.

Next, the registration unit 102 performs a sequence registration process in response to a sequence registration request. Specifically, the registration unit 102 generates a registered motion sequence by arranging the registered motion IDs in chronological order based on the information regarding the chronological order. The skeletal information extracted from video data obtained by imaging various dances (for example, hip hop and tango) by expert dancers may be registered as a sample motion sequence as it is. The sample motion sequence is also referred to as a sample motion pattern. At this time, in a case where the sequence registration request is related to the first sample motion (for example, hip hop), the registration unit 102 registers the generated registered motion sequence in the sample motion sequence table 104 as a first sample motion sequence SA1. On the other hand, in a case where the sequence registration request is related to the second sample motion (for example, tango), the registration unit 102 registers the generated registered motion sequence in the sample motion sequence table 104 as a second sample motion sequence SA2. The sample motion may be registered for each type or difficulty (for example, for an advanced-level person, an intermediate-level person, and a beginner) of dance. Even in the same dance, a separate sample motion sequence may be registered for each body part of interest (for example, an upper part from the neck, a lower body, and the like). In other words, different sample motion sequences can have different evaluation criteria. Each registered motion sequence may be registered along with information regarding a body part of interest in evaluation and the degree of focus for each part. In several example embodiments, the registered motion sequence can be the same as the sample motion sequence.

The motion DB 103 is a storage device that stores registered skeletal information corresponding to each of unit motions (for example, a box step) included in the predetermined motion (for example, a dance) in association with the registered motion ID.

The sample motion sequence table 104 stores many sample motion sequences SA1, SA2, . . . , SAN. The sample motion sequence is also referred to as a sample motion pattern and can be used to evaluate a motion by comparing the sample motion pattern with the motion of the person and calculating similarity between the sample motion pattern and the motion of the person.

The selection unit 105 is also referred to as selection means. The selection unit 105 selects at least one desired sample motion pattern from a plurality of sample motion patterns by selecting an evaluator or the like of the motion of the user through the selection unit 206. Alternatively, the selection unit 105 may select one corresponding sample motion pattern according to music (for example, dance music) to be reproduced acquired through the microphone 205. When a plurality of sample motion patterns is selected, the selection unit 105 may set different weighting for each sample motion pattern. That is, an evaluation value may be calculated in consideration of different weighting of each of a plurality of sample motion patterns. Alternatively, an average value, a median value, a maximum value, a minimum value, or the like of evaluation values that are based on the plurality of sample motion patterns may be used. Accordingly, the evaluator or the like can select a part of the body of interest by himself or herself and appropriately evaluate the part.

The image acquisition unit 106 is also referred to as image acquisition means. The image acquisition unit 106 acquires video data captured by the camera 300 during running of the motion evaluation apparatus 100. That is, the image acquisition unit 106 acquires the video data in response to detection of a start trigger. The image acquisition unit 106 supplies the frame image included in the acquired video data to the extraction unit 107.

The extraction unit 107 is also referred to as extraction means. The extraction unit 107 detects an image region (body region) of the body of the person from the frame image included in the video data and extracts the image region as a body image (for example, cutting). Then, the extraction unit 107 extracts the skeletal information of at least a part of the body of the person based on features such as joints of the person recognized in the body image using a skeleton estimation technique using machine learning. The skeletal information is information including a “key point” which is a characteristic point such as a joint and a “bone (or bone link)” indicating a link between key points. The extraction unit 107 may use, for example, a skeleton estimation technique such as OpenPose. The extraction unit 107 supplies the extracted skeletal information to the motion identification unit 108.

The motion identification unit 108 is also referred to as motion identification means. The motion identification unit 108 converts the skeletal information extracted from the video data acquired during running into a motion ID using the motion DB 103. Accordingly, the motion identification unit 108 identifies a motion. Specifically, the motion identification unit 108 first identifies, from the registered skeletal information registered in the motion DB 103, registered skeletal information in which similarity to the skeletal information extracted by the extraction unit 107 is equal to or greater than a predetermined threshold. Then, the motion identification unit 108 identifies the registered motion ID associated with the identified registered skeletal information as the motion ID corresponding to the person included in the acquired frame image.

Here, the motion identification unit 108 may identify one motion ID based on the skeletal information corresponding to one frame image or may identify one motion ID based on chronological data of the skeletal information corresponding to each of a plurality of frame images. The motion identification unit 108 may identify skeletal information having higher weighting regarding a part of interest included in the sample motion than a threshold. Accordingly, the motion identification unit 108 can be interested in even a part of which a motion is small.

In another example embodiment, when one motion ID is identified using a plurality of frame images, the motion identification unit 108 may extract only skeletal information having a large motion and collate the extracted skeletal information with the registered skeletal information in the motion DB 103. Extracting only the skeletal information having a large motion may mean extracting skeletal information in which a difference between pieces of skeletal information of different frame images included within a predetermined period is a predetermined amount or more. Because of such a small amount of collation, a calculation load can be reduced, and the amount of registered skeletal information is also small. Since only skeletal information having a large motion is used as a collation target despite a duration of the motion differs depending on the person, robustness for the motion detection can be achieved.

In addition to the above-described method, various methods can be considered in the identification of the motion ID. For example, there is a method of estimating a motion ID from target video data using a motion estimation model in which video data correctly assigned by the motion ID is learned as learning data. However, it is difficult to collect the learning data, and cost is expensive. Meanwhile, in the second example embodiment, the skeletal information is used for estimating the motion ID, and is compared with the skeletal information registered in advance using the motion DB 103. Accordingly, in the second example embodiment, the motion evaluation apparatus 100 can more easily identify the motion ID.

The generation unit 109 is also referred to as generation means. The generation unit 109 generates a motion sequence based on the plurality of motion IDs identified by the motion identification unit 108. The motion sequence includes a plurality of motion IDs chronologically. The generation unit 109 supplies the generated motion sequence to the evaluation unit 110.

The evaluation unit 110 is also referred to as evaluation means. The evaluation unit 110 determines whether the generated motion sequence matches (corresponds to) the sample motion sequence (for example, the first sample motion SA1) registered in the motion sequence table 104 and selected by the selection unit 105.

In several example embodiments, the evaluation unit 110 can evaluate the similarity between the sample motion and the evaluation target motion in consideration of the deviation amount in the temporal axis direction between the sample motion and the evaluation target motion on the same temporal axis. The evaluation unit 110 can evaluate the similarity between the sample motion and the evaluation target motion regardless of the temporal axis in consideration of the deviation amount of the geometric shape in the spatial axis direction of the extracted skeletal information of the person. Accordingly, it is possible to appropriately evaluate a motion of the person.

The processing control unit 111 is also referred to as processing control means. The processing control unit 111 outputs information regarding an evaluation result of the generated motion sequence. In this case, the processing control unit 111 is also referred to as output means. The processing control unit 111 can causes the display unit 203 to display the evaluation result. Alternatively, the processing control unit 111 can cause the voice output unit 204 to output the evaluation result as a voice.

For example, a display mode (fonts, colors, thicknesses, blinking, and the like of characters) in a case where the information regarding the evaluation is displayed may be changed in accordance with the evaluation result, or a volume or a sound itself in a case where the information regarding the evaluation is output as a voice may be changed. Accordingly, the evaluator or the user himself or herself performing a motion can recognize evaluation content and quickly and appropriately cope with the evaluation content to improve the motion. The processing control unit 111 may record a time, a place, and a video at which a motion with the predetermined evaluation (bad evaluation) is performed as the history information along with the evaluation information. Accordingly, the evaluator or the moving user himself or herself can recognize content of the evaluation and appropriately improve the motion to receive good evaluation.

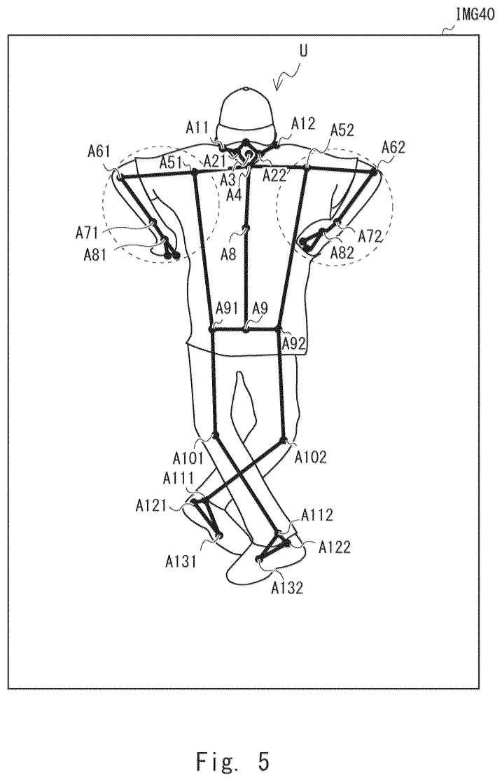

FIG. 5 is a diagram illustrating skeletal information extracted from a frame image IMG40 included in video data according to the second example embodiment. The frame image IMG40 includes an image region of the whole body of the user U when the user U performing a dance is imaged from the front. The skeletal information illustrated in FIG. 5 includes a plurality of key points and a plurality of bones detected from the upper body. As an example, FIG. 5 illustrates, as key points, a right ear A11, a left ear A12, a right eye A21, a left eye A22, a nose A3, a neck A4, a right shoulder A51, a left shoulder A52, a right elbow A61, a left elbow A62, a right wrist A71, a left wrist A72, a palm A81 of the right hand, a palm A82 of the left hand, a center A8 of the chest, a right waist A91, a belly A9, a left waist A92, a right knee A101, a left knee A102, a right ankle A111, a left ankle A112, a right heel A121, a left heel A122, a right foot A131, and a left foot A132.

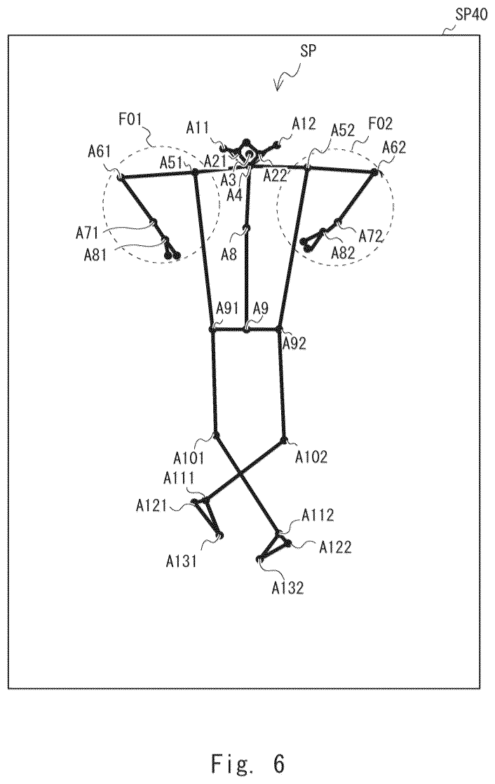

The motion evaluation apparatus 100 evaluates each motion by comparing the skeletal information with the registered skeletal information corresponding to the whole body in the sample motion and determining whether the skeletal information is similar to the registered skeletal information. FIG. 6 illustrates an example of the registered skeletal information extracted from the sample image SP40 of the corresponding sample motion (also denoted SP in the drawing). Parts F01 and F02 of interest can also be registered in the registered skeletal information. The part of interest can include one or more regions of the body. The part of interest may be arbitrarily set by the evaluator via the operation unit 206 of the motion evaluation apparatus 100.

For example, in the dance motion illustrated in FIG. 6, motions of the right hand and the left hand may be important. Accordingly, the motion evaluation apparatus 100 may calculate and evaluate the similarity by weighting the part F01 including the right shoulder A51, the right elbow A61, the right wrist A71, and the palm A81 of the right hand and the part F02 including the left shoulder A52, the left elbow A62, the left wrist A72, and the palm A82 of the left hand. For example, the similarity between these parts can be more accurately evaluated by enhancing the weighting than other parts. In several example embodiments, only the part of interest may be evaluated and the other parts may not be evaluated.

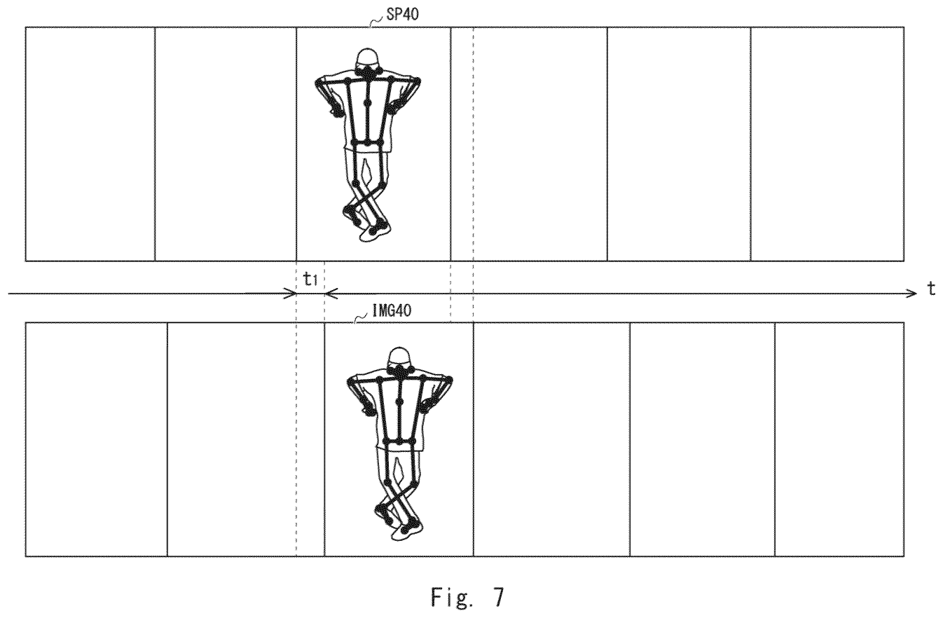

FIG. 7 is a diagram illustrating an example in which the similarity is evaluated in consideration of the deviation amount in the temporal axis direction between the sample motion and the evaluation target motion. The horizontal axis represents a time (seconds). A plurality of frame images arranged chronologically in relation to the sample motion data are illustrated above the horizontal axis. A plurality of frame images arranged chronologically in relation to evaluation target motion data are illustrated below the horizontal axis. The sample motion data and the evaluation target motion data can be arranged on the same temporal axis by matching start times of the motion or the dance music, for example. As illustrated in FIG. 7, the evaluation target motion is delayed by a time t₁ (seconds) with respect to the sample motion. In this way, according to the present example embodiment, the motion can be evaluated in consideration of not only a deviation amount (or similarity) in a geometric shape between the skeletal information regarding the sample motion and the skeletal information regarding the evaluation target motion but also a deviation in the temporal axis direction on the same temporal axis.

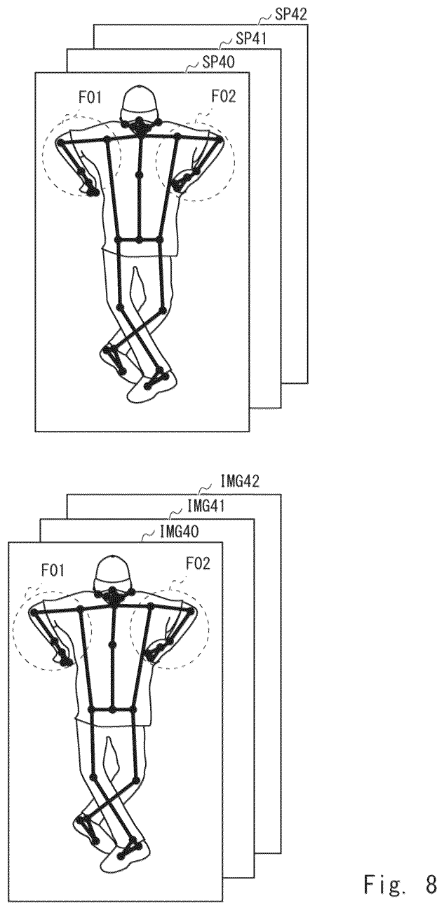

FIG. 8 is a diagram illustrating an example in which the similarity is evaluated in consideration of the deviation amount in the spatial axis direction at a synchronization time between the skeletal information of the sample motion and the skeletal information of the evaluation target motion. The upper portion of FIG. 8 illustrates the skeletal information of the sample motion, and the lower part of FIG. 8 illustrates the skeletal information of the evaluation target motion. The sample motion pattern is also registered and stored for each frame. The skeletal information regarding the evaluation target motion is also acquired for each frame. Regardless of a time, similarity is calculated by associating (or synchronizing) frames having similar skeleton shapes with each other, and comparing the deviation in the spatial axis direction. In the evaluation, an angle of each bone can be calculated. In order to offset the difference in body shape between a dancer performing the sample motion and a dancer performing the evaluation target motion, the sizes (that is, the length of the bone) of the skeletons of both the dancers may be normalized. Accordingly, for example, a pseudo skeleton of the evaluation target motion can indicate that the left elbow is lowered from the left shoulder with respect to the pseudo skeleton of the sample motion. In this case, by calculating the similarity in the geometric shape of the pseudo skeleton between the sample motion and the evaluation target motion without considering the deviation in the temporal axis direction, for example, it is possible to indicate that the evaluation target motion is a slower motion than the sample motion but a form of the motion is matched in the evaluation target motion.

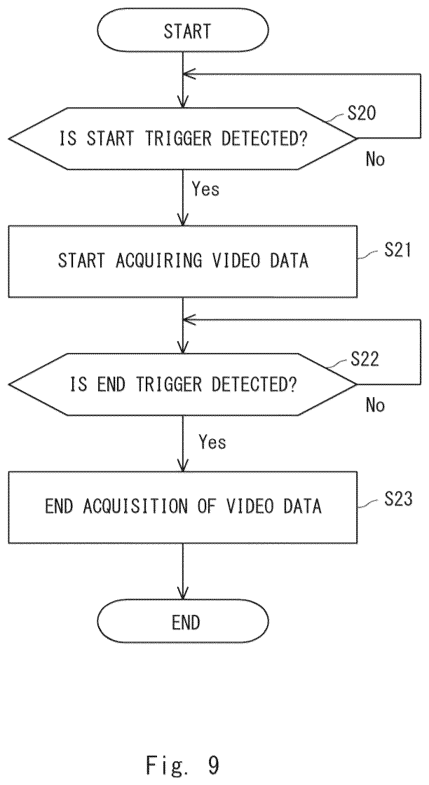

FIG. 9 is a flowchart illustrating a video data acquisition method by the motion evaluation apparatus 100 according to the second example embodiment. First, the control unit 202 of the motion evaluation apparatus 100 determines whether a start trigger is detected (S20). In a case where it is determined that the start trigger is detected (Yes in S20), the control unit 202 starts acquiring the video data from the camera 300 to the motion evaluation apparatus 100 (S21). Conversely, in a case where it is not determined that the start trigger is detected (No in S20), the control unit 202 repeats the process illustrated in S20.

Subsequently, the control unit 202 of the motion evaluation apparatus 100 determines whether an end trigger is detected (S22). When it is determined that the end trigger is detected (Yes in S22), the control unit 202 ends the acquisition of the video data from the camera 300 to the motion evaluation apparatus 100 (S23). Conversely, when it is determined that the end trigger is not detected (No in S22), the control unit 202 repeats the processing illustrated in S22 while executing the transmission of the video data.

In this way, by limiting a video data acquisition period to a period between the predetermined start trigger and the predetermined end trigger, it is possible to inhibit an amount of communication data to a minimum. Since the motion detection process in the motion evaluation apparatus 100 can be omitted outside of the period, calculation resources can be saved.

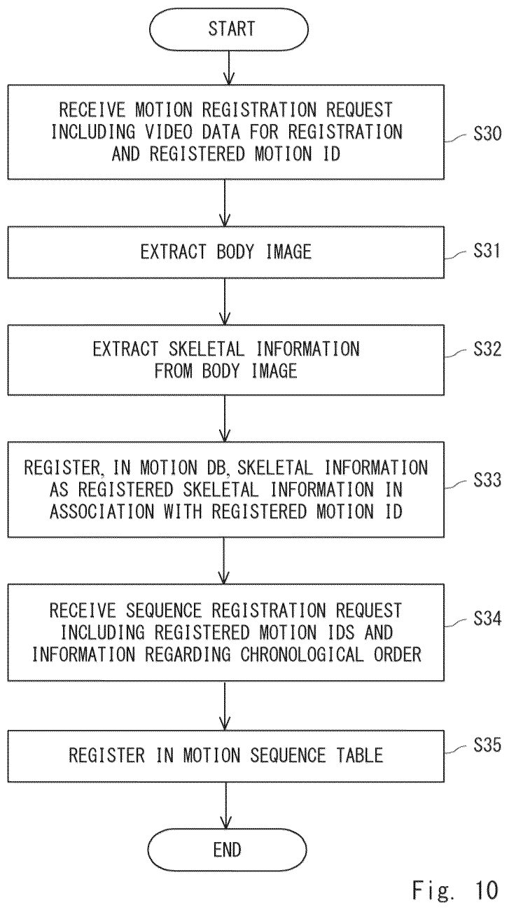

FIG. 10 is a flowchart illustrating a method of registering a registered motion ID and a registered motion sequence by the motion evaluation apparatus 100 according to the second example embodiment. First, the registered information acquisition unit 101 of the motion evaluation apparatus 100 receives a motion registration request including the video data for registration and the registered motion ID from the motion evaluation apparatus 100 (S30). Subsequently, the registration unit 102 supplies the video data for registration to the extraction unit 107. When, the extraction unit 107 acquiring the video data for registration extracts a body image from a frame image included in the video data for registration (S31). Subsequently, the extraction unit 107 extracts the skeletal information from the body image (S32). Next, the registration unit 102 acquires the skeletal information from the extraction unit 107 and registers, in the motion DB 103, the acquired skeletal information as registered skeletal information in association with the registered motion ID (S33). The registration unit 102 may set all pieces of skeletal information extracted from the body image as registered skeletal information or may set only some pieces of skeletal information (for example, skeletal information of shoulders, elbows, and hands) as registered skeletal information.

Subsequently, the registered information acquisition unit 101 receives a sequence registration request including a plurality of registered motion IDs and information regarding the chronological order of each motion from the motion evaluation apparatus 100 (S34). Subsequently, the registration unit 102 registers the registered motion sequence (sample motion sequence SA) in which the registered motion IDs are arranged based on information regarding the chronological order in the motion sequence table 104 (S35). Then, the motion evaluation apparatus 100 ends the process.

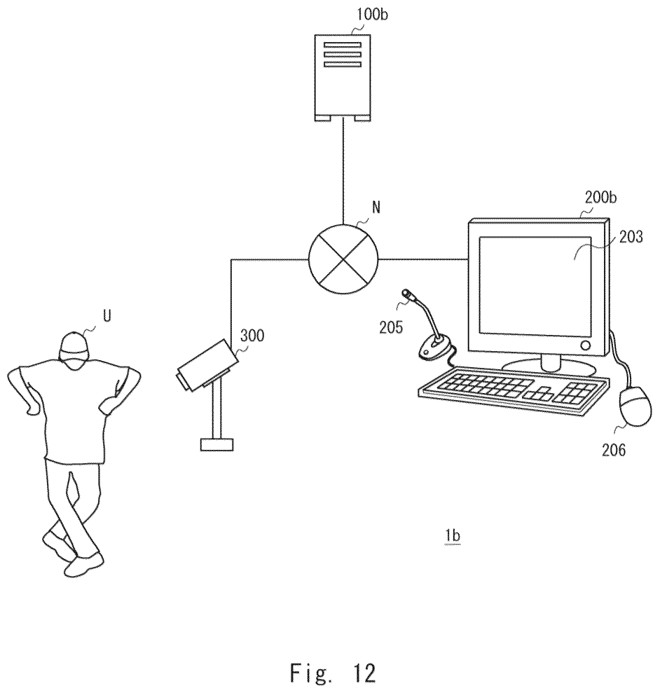

FIG. 12 is a flowchart illustrating a motion evaluation method by the motion evaluation apparatus 100 according to the second example embodiment. First, when the image acquisition unit 106 of the motion evaluation apparatus 100 starts acquiring the video data from the motion evaluation apparatus 100 (Yes in S40), the extraction unit 107 extracts the body image from the frame image included in the video data (S41). Next, the extraction unit 107 extracts the skeletal information from the body image (S42). The motion identification unit 108 calculates similarity between at least a part of the extracted skeletal information and each piece of registered skeletal information registered in the motion DB 103 and identifies the registered motion ID associated with registered skeletal information having a similarity equal to or greater than the predetermined threshold as a motion ID (S43). Subsequently, the generation unit 109 adds the motion ID to the motion sequence. Specifically, the generation unit 109 sets the motion ID identified in S43 as the motion sequence in the first cycle and adds the motion ID identified in S43 to the already generated motion sequence in the subsequent cycles. Then, the motion evaluation apparatus 100 determines whether the predetermined motion (for example, a dance) is finished or the acquisition of the video data ends (S45). The motion evaluation apparatus 100 may determine that the dance is finished when the motion identified in S43 of the current cycle is the motion with the predetermined registered motion ID. When the motion evaluation apparatus 100 determines that the dance is finished or the acquisition of the video data ends (Yes in S45), the process proceeds to S46. Otherwise (No in S45), the process returns to S41, and the process of adding the motion sequence is repeated.

In S46, the evaluation unit 110 determines whether the evaluation target motion sequence corresponds to the selected sample motion sequence SA of the sample motion sequence table 104. Specifically, the evaluation unit 110 evaluates the similarity between the evaluation target motion sequence and the sample motion sequence SA in consideration of the deviation in the temporal axis direction (S46). Subsequently, the evaluation unit 110 evaluates the similarity between each unit motion in the evaluation target motion sequence and each motion of the sample motion sequence SA in consideration of the deviation in the spatial axis direction (S47).

The processing control unit 111 outputs the evaluation display information according to the evaluation result (for example, in the display unit 203) (S48). Then, the motion evaluation apparatus 100 ends the process.

In this way, according to the second example embodiment, the motion evaluation apparatus 100 can evaluate a motion flow and a motion form of the user U by comparing the motion sequence indicating the motion flow of the user U with the sample motion sequence SA.

### Third Example Embodiment

In a third example embodiment, the server performs parts of the motion detection and the evaluation process with a large processing load.

FIG. 12 is a diagram illustrating an overall configuration of a motion evaluation system 1b according to the third example embodiment. The motion evaluation system 1b is a computer system that images the user U performing a predetermined motion and comparing the predetermined motion with a sample motion to evaluate a motion of the user U.

The motion evaluation system 1b includes a motion evaluation apparatus 100b, a terminal apparatus 200b, and a camera 300. The motion evaluation apparatus 100b is communicably connected to the camera 300 and the terminal apparatus 200 via the network N. The network N may be wired or wireless. The motion evaluation apparatus 100b may be a server computer. The terminal apparatus 200 may be a local computer (for example, a desktop computer, a laptop computer, a tablet, a smartphone, or the like).

FIG. 12 is a block diagram illustrating configurations of the motion evaluation apparatus 100b and the terminal apparatus 200b according to the third example embodiment.

### (Terminal Apparatus 200b)

The terminal apparatus 200b includes a communication unit 201b, a control unit 202, a display unit 203, a voice output unit 204, a microphone 205, and an operation unit 206.

Since a basic configuration is similar to that of the second example embodiment, a detailed description thereof will be omitted here. The communication unit 201 appropriately transmits the video data acquired from the camera 300 to the motion evaluation apparatus 100b.

### (Motion Evaluation Apparatus 100b)

The motion evaluation apparatus 100b includes a registered information acquisition unit 101, a registration unit 102, a motion DB 103, a sample motion sequence table 104, a selection unit 105, an image acquisition unit 106b, an extraction unit 107, a motion identification unit 108, a generation unit 109, an evaluation unit 110, and a processing control unit 111b.

Since a basic configuration is similar to that of the second example embodiment, a detailed description thereof will be omitted here. The image acquisition unit 106b acquires video data from the camera 300 via the network via the communication unit 201b of the terminal apparatus 200b. The motion evaluation apparatus 100b evaluates a motion, as described above. Thereafter, the processing control unit 111b replies to the terminal apparatus 200b with an evaluation result.

### Other Example Embodiments

In other example embodiments, the camera 300 can also be an intelligent camera. In this case, the camera 300 includes a processor, a memory, and various image sensors. Such an intelligent camera can include some or all of the constituents of the foregoing motion evaluation apparatus 100.

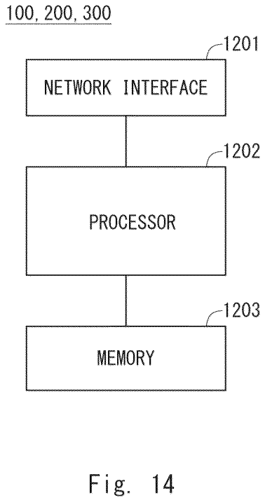

FIG. 14 is a block diagram illustrating a hardware configuration example of the motion evaluation apparatus 100 and the terminal apparatus 200 (hereinafter referred to as the motion evaluation apparatus 100 or the like). Referring to FIG. 14, the motion evaluation apparatus 100 or the like includes a network interface 1201, a processor 1202, and a memory 1203. The network interface 1201 is used to communicate with other network node apparatuses that configure the communications system. The network interface 1201 may be used to perform wireless communication. For example, the network interface 1201 may be used to perform wireless LAN communication defined in IEEE 802.11 series or mobile communication defined in 3rd Generation Partnership Project (3GPP). Alternatively, the network interface 1201 may include, for example, a network interface card (NIC) in conformity with IEEE 802.3 series.

The processor 1202 performs processing of the motion evaluation apparatus 100 or the like described with reference to the flowchart or sequence in the above-described example embodiment by reading and executing software (computer program) from the memory 1203. The processor 1202 may be, for example, a microprocessor, a micro processing unit (MPU), or a central processing unit (CPU). The processor 1202 may include a plurality of processors.

The memory 1203 is configured in a combination of a volatile memory and a nonvolatile memory. The memory 1203 may include a storage located away from the processor 1202. In this case, the processor 1202 may access the memory 1203 through an I/O interface (not illustrated).

In the example in FIG. 14, the memory 1203 is used to store a software module group. The processor 1202 can perform the processing of the motion evaluation apparatus 100 or the like described in the above-described example embodiment by reading and executing the software module group from the memory 1203.

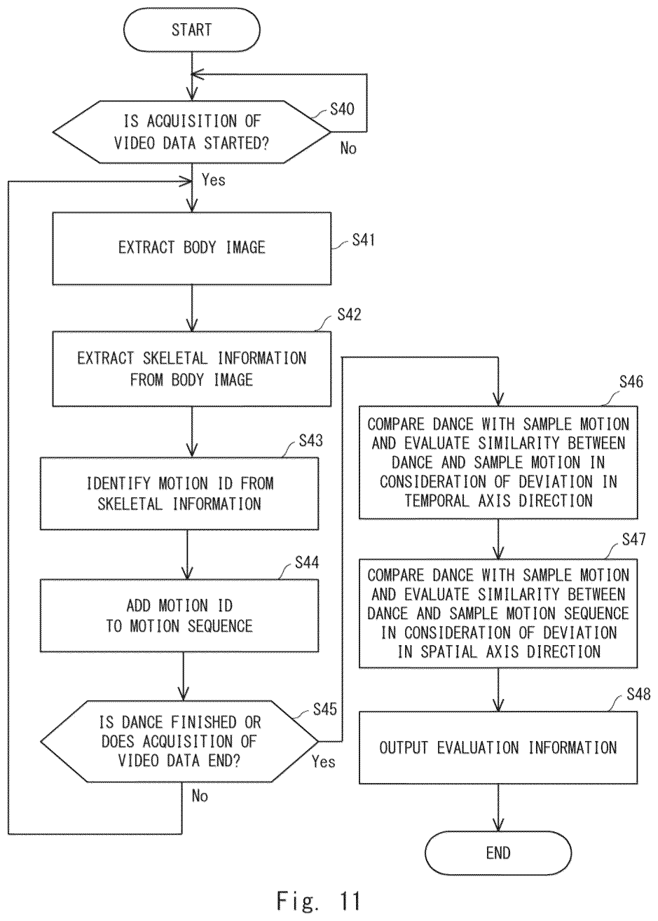

As described with reference to FIGS. 2, 11, and the like, each of the processors included in the motion evaluation apparatus 100 or the like executes a single program or a plurality of programs including a command group for causing a computer to perform an algorithm described with reference to the drawings.

In the above-described example embodiment, the configuration of the hardware has been described, but the present invention is not limited thereto. The present disclosure can also be implemented by causing a processor to execute a computer program.

Although the example embodiments of the present invention have been described, the example embodiments are examples of the present invention, and various configurations other than the above can be adopted. The configurations of the above-described example embodiments may be combined with each other, or some configurations may be replaced with other configurations. Various modifications of the configurations of the above-described example embodiments may be made within the scope without departing from the gist. The configurations and processes disclosed in the above-described example embodiments and modified example may be combined with each other.

In the plurality of flowcharts used in the above description, the plurality of steps (processes) has been described in order, but an execution order of the steps executed in each example embodiment is not limited to the described order. In each example embodiment, the order of the illustrated steps can be changed within a range in which there is no problem in content. The above-described example embodiments can be combined within a range in which the content is not contradictory.

In the above-described example, the program includes a command group (or software codes) for causing a computer to perform one or more functions described in the example embodiments when the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, a magnetic disk storage, and any other magnetic storage devices. The program may be transmitted on a transitory computer-readable medium or a communication medium. By way of example, and not limitation, transitory computer-readable or communication media include electrical, optical, or acoustic propagated signals or other forms of propagated signals.

Some or all of the above-described example embodiments may be described as in the following supplementary notes, but are not limited to the following Supplementary Notes.

### (Supplementary Note 1)

A motion evaluation apparatus including:
motion identification means for extracting skeletal information of a person in an acquired image and identifying an evaluation target motion related to a body of the person based on the extracted skeletal information of the person and a registered motion pattern formed by stored skeletal information; and
evaluation means for evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

### (Supplementary Note 2)

The motion evaluation apparatus according to Supplementary Note 1, wherein the deviation amount of the skeletal information in the temporal axis direction is calculated from a distance between associated frames by matching the sample motion pattern with a motion start point of the evaluation target motion and associating each frame based on similarity of the skeletal information of each frame.

### (Supplementary Note 3)

The motion evaluation apparatus according to Supplementary Note 1, wherein the deviation amount of the skeletal information in the spatial axis direction is obtained by associating a sample motion and an evaluation target motion similar to each other and calculating a deviation amount of a geometric shape of the skeletal information.

### (Supplementary Note 4)

The motion evaluation apparatus according to Supplementary Note 1, wherein the motion identification means identifies an evaluation target motion based on instruction information of a user.

### (Supplementary Note 5)

The motion evaluation apparatus according to any one of Supplementary Notes 1 to 4, further including selection means for selecting at least one sample motion pattern from a plurality of sample motion patterns formed by skeletal information for evaluating a motion of the person and having different evaluation criteria for a body part of interest.

### (Supplementary Note 6)

The motion evaluation apparatus according to Supplementary Note 1, wherein, after the skeletal information related to the evaluation target motion and the skeletal information related to the sample motion pattern are normalized, the evaluation means evaluates the deviation amount of the skeletal information of the person in the spatial axis direction.

### (Supplementary Note 7)

The motion evaluation apparatus according to any one of Supplementary Notes 1 to 6, further including output means for outputting an evaluation result regarding the evaluation.

### (Supplementary Note 8)

The motion evaluation apparatus according to any one of Supplementary Notes 1 to 7, wherein the motion identification means identifies an evaluation target motion related to a body part by setting a feature point and a pseudo skeleton of the body of the person in image data.

### (Supplementary Note 9)

The motion evaluation apparatus according to any one of Supplementary Notes 1 to 8, wherein the motion identification means identifies a motion of the body in chronological order based on a plurality of consecutive image frames.

### (Supplementary Note 10)

The motion evaluation apparatus according to any one of Supplementary Notes 1 to 9, further including storage means for storing a plurality of sample motion patterns and a plurality of registered motion patterns.

### (Supplementary Note 11)

The motion evaluation apparatus according to any one of Supplementary Notes 1 to 10, further including storage means for storing evaluation criteria information including a plurality of evaluation criteria corresponding to a plurality of different parts.

### (Supplementary Note 12)

The motion evaluation apparatus according to Supplementary Note 11, wherein the evaluation means evaluates similarity for each predetermined part in the body based on the evaluation criteria.

### (Supplementary Note 13)

The motion evaluation apparatus according to Supplementary Note 5, wherein the selection means selects one sample motion pattern based on voice data related to an input or a motion from an input means.

### (Supplementary Note 14)

The motion evaluation apparatus according to any one of Supplementary Notes 1 to 13, wherein the registered motion pattern includes the sample motion pattern.

### (Supplementary Note 15)

A motion evaluation method including:
extracting skeletal information of a person in an acquired image and identifying an evaluation target motion based on the extracted skeletal information of the person and a registered motion pattern formed by stored skeletal information; and
evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

### (Supplementary Note 16)

A non-transitory computer-readable medium storing a program that causes a computer to execute:
a process of extracting skeletal information of a person in an acquired image and identifying an evaluation target motion based on the extracted skeletal information of the person and a registered motion pattern formed by stored skeletal information; and
a process of evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

### REFERENCE SIGNS LIST

1, 1b MOTION EVALUATION SYSTEM
100, 100a, 100b MOTION EVALUATION APPARATUS
101 REGISTERED INFORMATION ACQUISITION UNIT
102 REGISTRATION UNIT
103 MOTION DB
104 SAMPLE MOTION SEQUENCE TABLE
105 SELECTION UNIT
106 IMAGE ACQUISITION UNIT
107 EXTRACTION UNIT
108, 108a MOTION IDENTIFICATION UNIT
109 GENERATION UNIT
110, 10a EVALUATION UNIT
111 PROCESSING CONTROL UNIT
200b TERMINAL APPARATUS
201 COMMUNICATION UNIT
202 CONTROL UNIT
203 DISPLAY UNIT
204 VOICE OUTPUT UNIT
205 MICROPHONE
206 OPERATION UNIT
300 CAMERA
SA SAMPLE MOTION SEQUENCE
IMG40 FRAME IMAGE
N NETWORK

What is claimed is:

1. A motion evaluation apparatus comprising:
at least one memory storing instructions, and
at least one processor configured to execute the instructions to;
extract skeletal information of a person in an acquired image;
identify an evaluation target motion related to a body of the person based on the extracted skeletal information of the person and a registered motion pattern formed by stored skeletal information; and
evaluate similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

2. The motion evaluation apparatus according to claim 1, wherein the deviation amount of the skeletal information in the temporal axis direction is calculated from a distance between associated frames by matching the sample motion pattern with a motion start point of the evaluation target motion and associating each frame based on similarity of the skeletal information of each frame.

3. The motion evaluation apparatus according to claim 1, wherein the deviation amount of the skeletal information in the spatial axis direction is obtained by associating a sample motion and an evaluation target motion similar to each other and calculating a deviation amount of a geometric shape of the skeletal information.

4. The motion evaluation apparatus according to claim 1, wherein the at least one processor is configured to execute the instructions to identify the evaluation target motion based on instruction information of a user.

5. The motion evaluation apparatus according to claim 1, wherein the at least one processor is configured to execute the instructions to select at least one sample motion pattern from a plurality of sample motion patterns formed by skeletal information for evaluating a motion of the person and having different evaluation criteria for a body part of interest.

6. The motion evaluation apparatus according to claim 1, wherein the at least one processor is configured to execute the instructions to evaluate the deviation amount of the skeletal information of the person in the spatial axis direction, after the skeletal information related to the evaluation target motion and the skeletal information related to the sample motion pattern are normalized.

7. The motion evaluation apparatus according to claim 1, wherein the at least one processor is configured to execute the instructions to output an evaluation result regarding the evaluation.

8. The motion evaluation apparatus according to claim 1, wherein the at least one processor is configured to execute the instructions to identify the evaluation target motion related to a body part by setting a feature point and a pseudo skeleton of the body of the person in image data.

9. The motion evaluation apparatus according to claim 1, wherein the at least one processor is configured to execute the instructions to identify a motion of the body in chronological order based on a plurality of consecutive image frames.

10. The motion evaluation apparatus according to claim 1, wherein the at least one processor is further configured to execute the instructions to store a plurality of sample motion patterns and a plurality of registered motion patterns.

11. The motion evaluation apparatus according to claim 1, wherein the at least one processor is further configured to execute the instructions to store evaluation criteria information including a plurality of evaluation criteria corresponding to a plurality of different parts.

12. The motion evaluation apparatus according to claim 11, wherein the at least one processor is configured to execute the instructions to evaluate similarity for each predetermined part in the body based on the evaluation criteria.

13. The motion evaluation apparatus according to claim 5, wherein the at least one processor is configured to execute the instructions to select one sample motion pattern based on voice data related to an input or a motion from an input unit.

14. The motion evaluation apparatus according to claim 1, wherein the registered motion pattern includes the sample motion pattern.

15. A motion evaluation method comprising:
extracting skeletal information of a person in an acquired image;
identifying an evaluation target motion based on the extracted skeletal information of the person and a registered motion pattern formed by stored skeletal information; and
evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.

16. A non-transitory computer-readable medium storing a program that causes a computer to execute:
a process of extracting skeletal information of a person in an acquired image;
a process of identifying an evaluation target motion based on the extracted skeletal information of the person and a registered motion pattern formed by stored skeletal information; and
a process of evaluating similarity between the evaluation target motion and a sample motion pattern formed by stored skeletal information, based on an integrated evaluation value including a first evaluation value that is based on a deviation amount of the skeletal information in a temporal axis direction and a second evaluation value that is based on a deviation amount of the skeletal information of the person in a spatial axis direction.
